(19) United States
(12) Patent Application Publication
(10) Pub. No.: US 2015/0028158 A1
(43) Pub. Date: Jan. 29, 2015

(54) Quick-Disconnecting Device, In Particular For Kite-Surf

(71) Applicant: Elimax LTD, Valletta (MT)

(72) Inventor: Marco Zangirolami, Borgo Ticino (IT)

(21) Appl. No.: 14/374,204

(22) PCT Filed: Jan. 9, 2013
(86) PCT No.: PCT/IT2013/000005

§ 371 Date: Jul. 23, 2014

(30) Foreign Application Priority Data
Jan. 24, 2012 (IT) TO2012A000059
May 23, 2012 (IT) TO2012A000446

(51) Int. Cl. B63B 35/79; F16G 11/10; B64C 31/06

(52) U.S. Cl. CPC B63B 35/7933; B63B 35/7953; B64C 31/06; B63B 35/7979; F16G 11/10
USPC 244/155 A

(57) ABSTRACT

A quick-disconnecting device (1), in particular for kite-surf, comprising a fixed element (3) and a moving element (5) having an operating connecting position in which the moving element (5) is kept integral with the fixed element (3) by interposing a blocking system (7), and an operating disconnecting position in which the moving element (5) is disengaged from the fixed element (3) by actuating the blocking system (7), such moving element (5) being equipped with a first connecting end (9), of a terminal (21) of a connecting element to by actuating the blocking system (7), such moving element (5) cooperating with the fixed element (3) through a lever-type dynamics around a fulcrum point (F) interposed between the moving element (5) and the fixed element (3), such device (1) further comprising an automatic fastening system (40) of the moving element (5) to the connecting element.

The present invention refers to a quick-disconnecting device, in particular for kite-surf.

Several applications are known, mostly in the sports environment, in which a user is connected through a harness or a trapezoid to a connecting element from which, due to safety reasons, he has to be able to be quickly and reliably disconnected.

One of these cases is the practice of kite-surf, in which the surfer or user is connected to the kite through a control bar that, in turn, is connected to a harness or trapezoid worn by the user through a connecting cable ending, usually, with a loop called “chicken loop”. A quick-disconnecting device is therefore interposed between such connecting cable and the trapezoid, such device usually engaging the chicken loop, and allowing, in case of need, to disconnect from the trapezoid, lower and neutralize the kite that, losing its wind, loses a great part of its own traction force, remaining connected to the surfer through a cable called “leash”.

Such known quick-disconnecting devices, however, still suffer from some inconveniences, that make their use scarcely practical and reliable.

First of all, in known devices, such as for example the classical “nail-type disconnection”, the control member that must be actuated by the user to perform the kite disconnection, is usually arranged in very close proximity with the chicken loop, that, above all in case of high and violent training by the kite, becomes difficult to be located, reached and actuated by the user.

Moreover, there are quick-disconnecting devices that use spinnaker catches, which however are very unreliable, because they do not always guarantee that the kite is disconnected and, above all those with pin-type opening, even if with slanted pin, get easily entangled and become useless when they are most needed.

Moreover, in known devices, it occurs that, once having disconnected the kite, a part of the device itself is able to suddenly slide with high speed inside a hand that a user has employed to actuate the device, with serious chances of injuring the hand itself.

Document DE-A1-10 2007 027305 discloses a quick-disconnecting device of a rope from a belt wherein moving element and fixed element are not mutually disconnected through a lever-type dynamics.

Therefore, object of the present invention is solving the above prior art problems, by providing a quick-disconnecting device, in particular for kite-surf, which can be practically, reliably and safely used.

Another object of the present invention is providing a quick-disconnecting device, in particular for kite-surf, equipped with at least one actuating handle arranged, with respect to the user body, always in a fixed and determined position, that therefore can be easily located and actuated by the user under any emergency circumstance.

Moreover, an object of the present invention is providing a quick-disconnecting device, in particular for kite-surf, in which no component thereof has the chance of passing through the user's hands upon disconnecting it.

Another object of the present invention is providing a quick-disconnecting device, in particular for kite-surf, that can be easily and quickly re-armed, and whose correct re-arming can be easily checked by a user.

Moreover, an object of the present invention is providing a quick-disconnecting device, in particular for kite-surf, equipped with an automatic re-loading system useful, above all, as safety help for beginner users of the device itself.

The above and other objects and advantages of the invention, as will appear from the following description, are obtained with a quick-disconnecting device, in particular for kite-surf, as claimed in claim 1. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could be made to what is described, without departing from the scope of the invention as appears from the enclosed claims.

The present invention will be better described by some preferred embodiments thereof, provided as a non-limiting example, with reference to the enclosed drawings, in which:

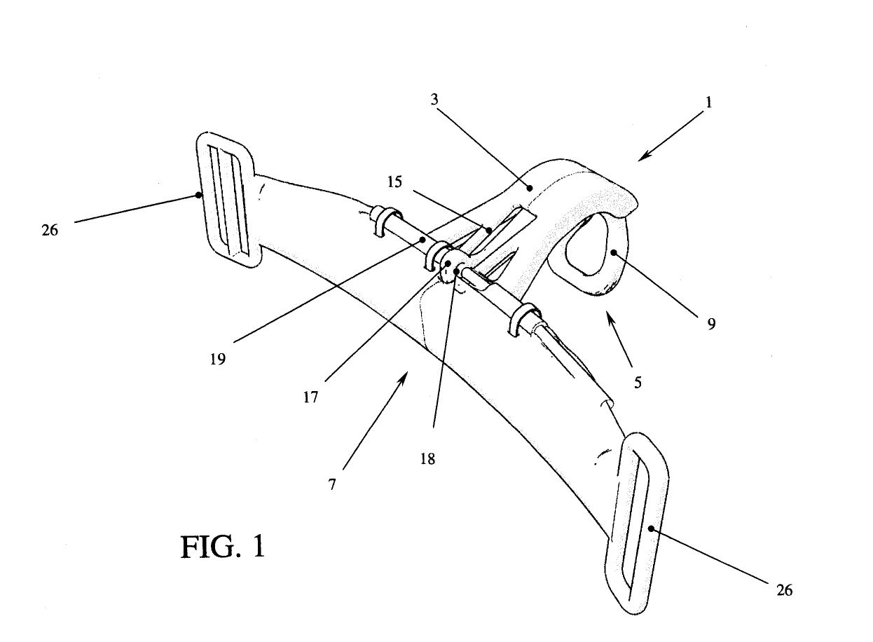

FIG. 1 shows a top perspective view of a preferred embodiment of the quick-disconnecting device according to the present invention;

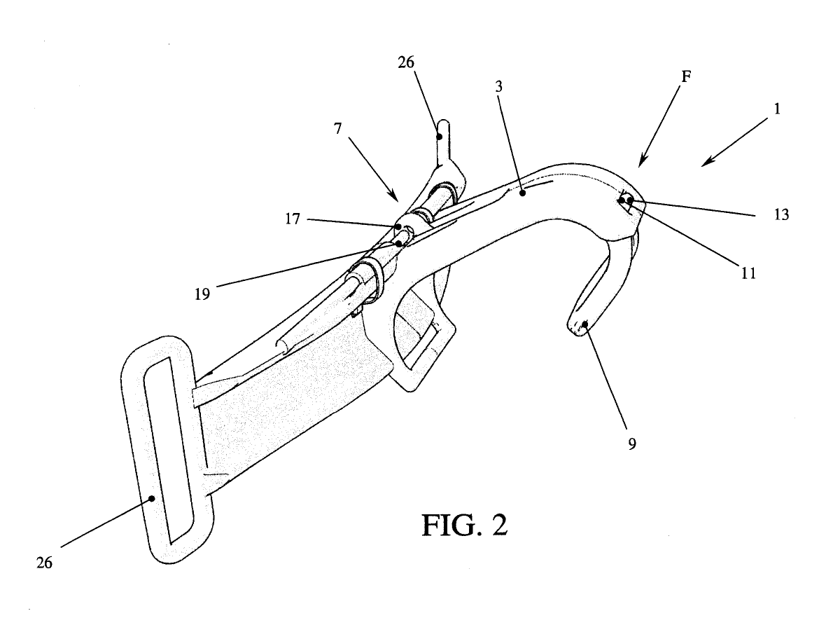

FIG. 2 shows another perspective view of the quick-disconnecting device of FIG. 1 in an operating connecting position;

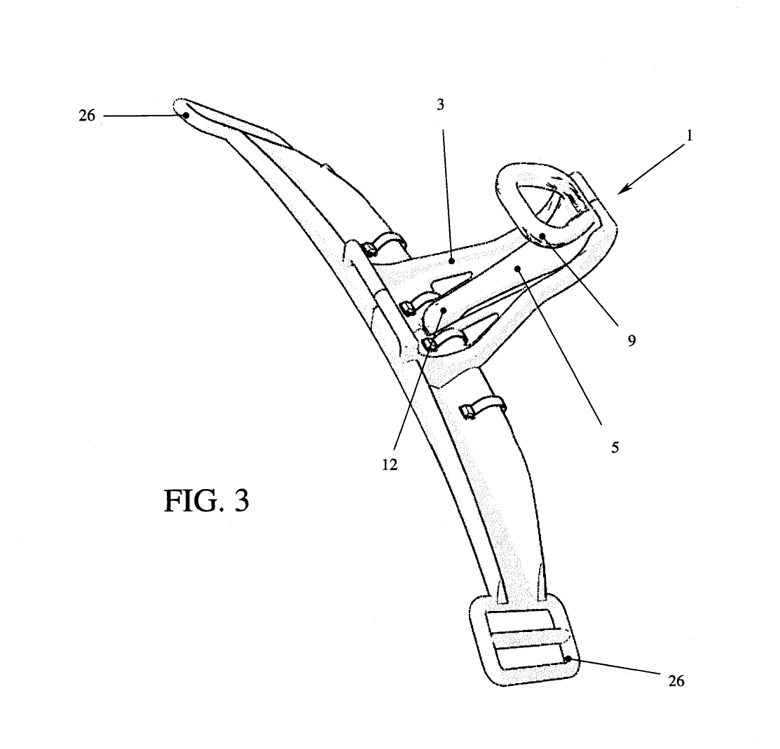

FIG. 3 shows another bottom view of the quick-disconnecting device of FIG. 1;

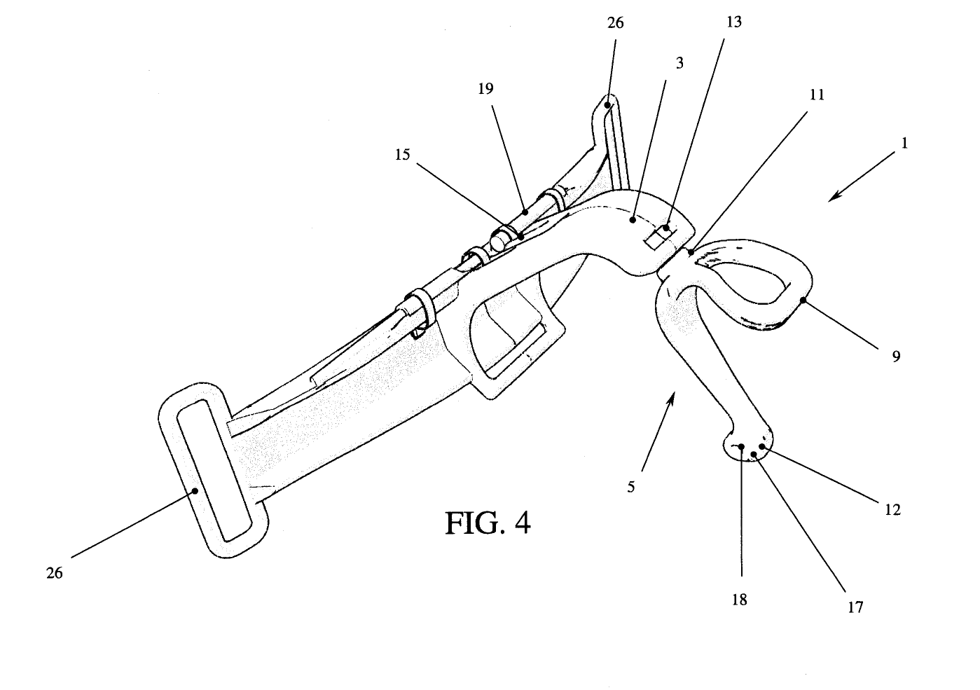

FIG. 4 shows another perspective view of the quick-disconnecting device of FIG. 1 in an operating disconnecting position;

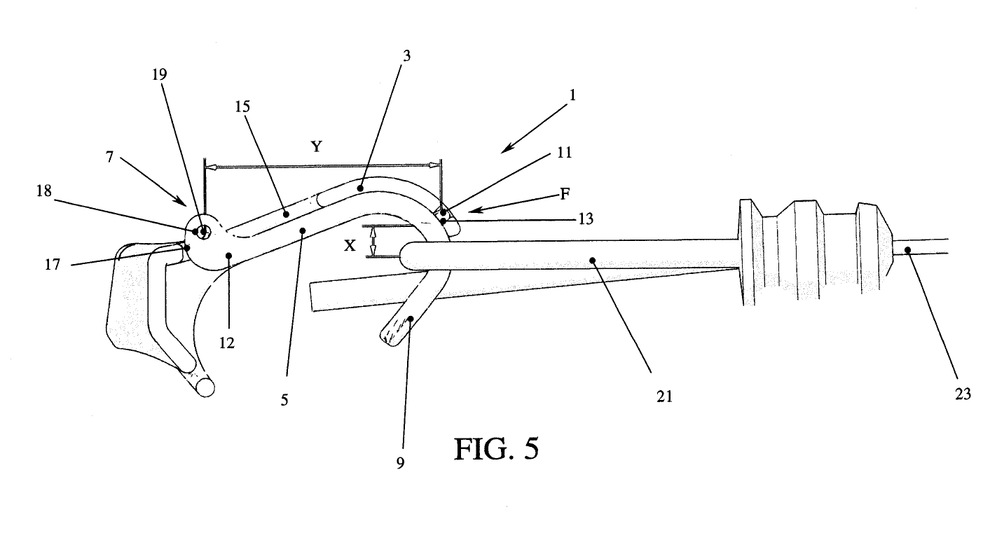

FIG. 5 shows a side view of another preferred embodiment of the quick-disconnecting device according to the present invention;

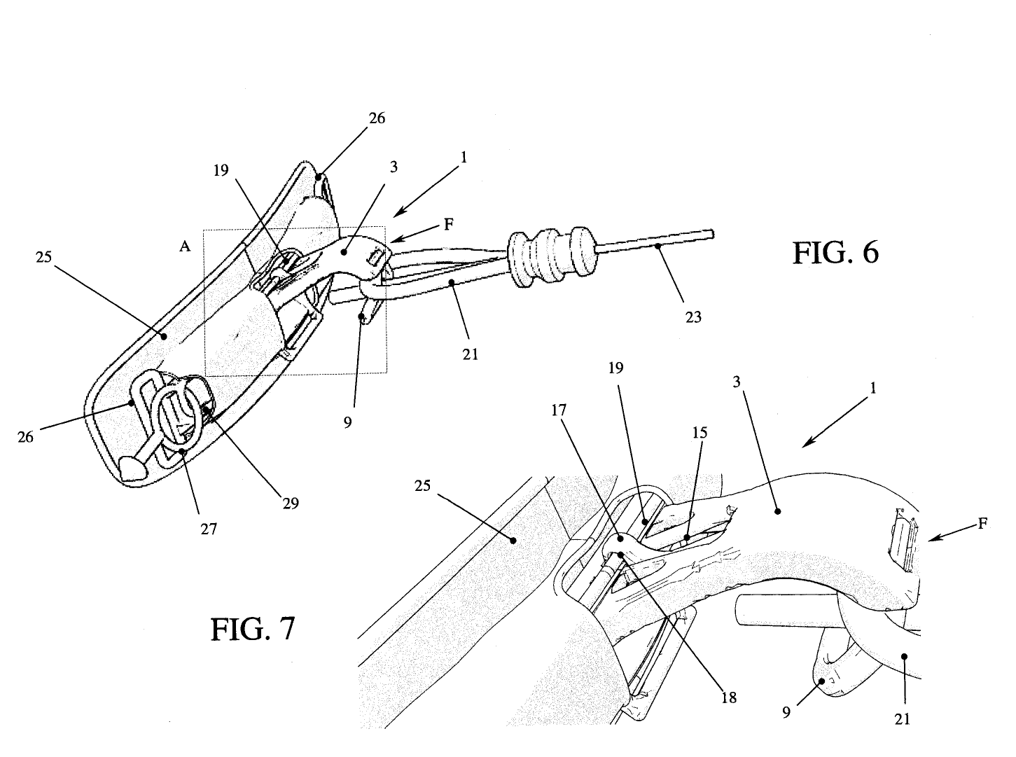

FIG. 6 shows a perspective view of a further preferred embodiment of the quick-disconnecting device according to the present invention in an operating connecting position;

FIG. 7 shows an enlarged view of the detail included in box A of FIG. 6;

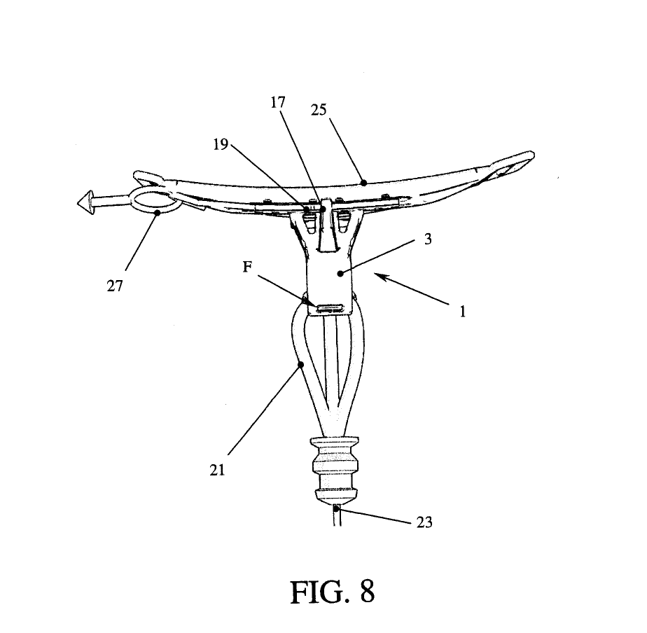

FIG. 8 shows a plan view of the quick-disconnecting device of FIG. 6;

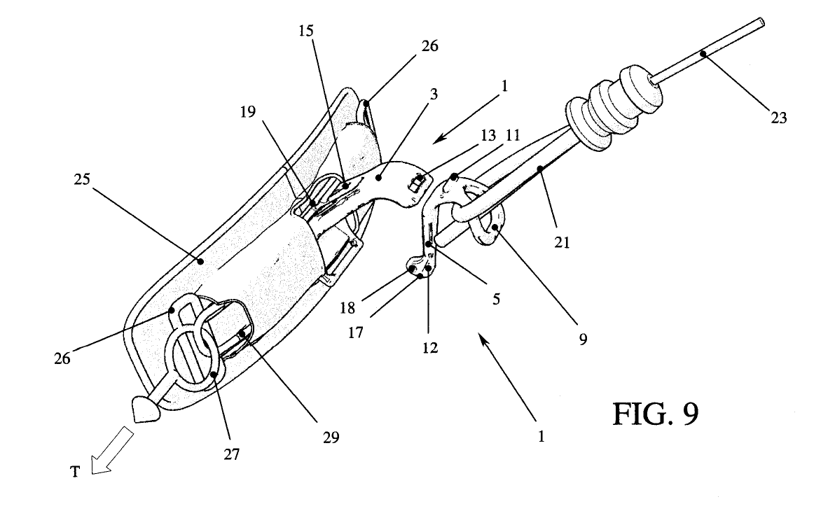

FIG. 9 shows another perspective view of the quick-disconnecting device of FIG. 6 in an operating disconnecting position;

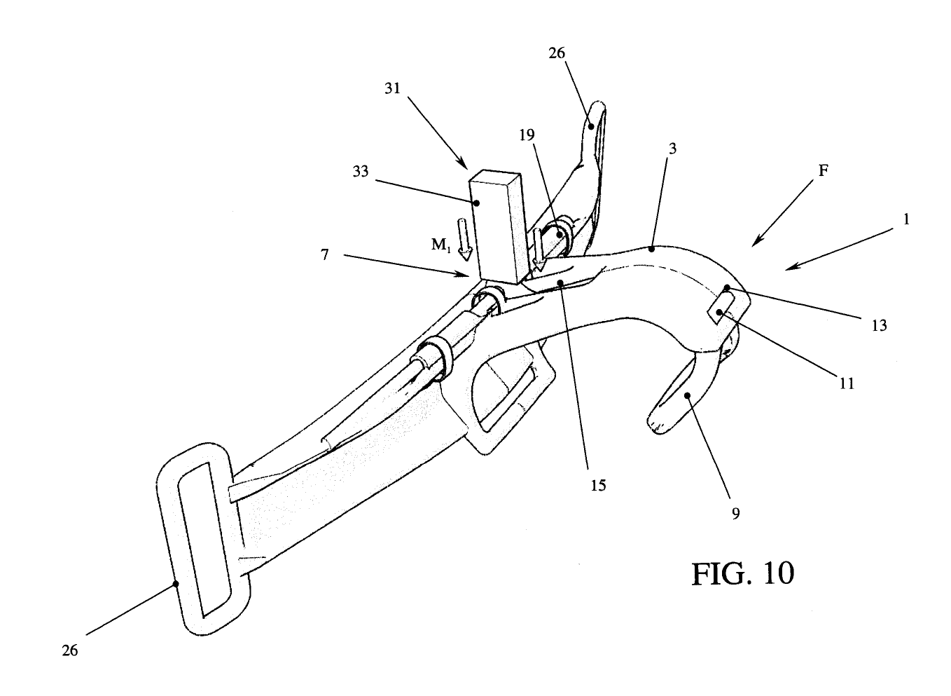

FIG. 10 shows a perspective view of a further preferred embodiment of the quick-disconnecting device according to the present invention in an operating disconnecting position;

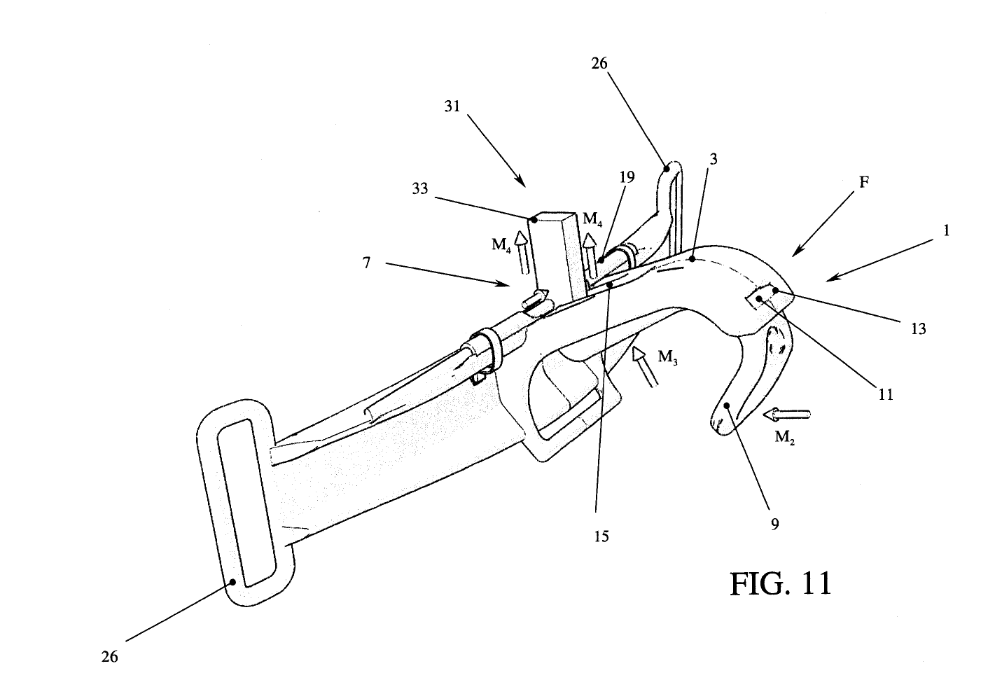

FIG. 11 shows another perspective view of the quick-disconnecting device of FIG. 10 in an operating connecting position;

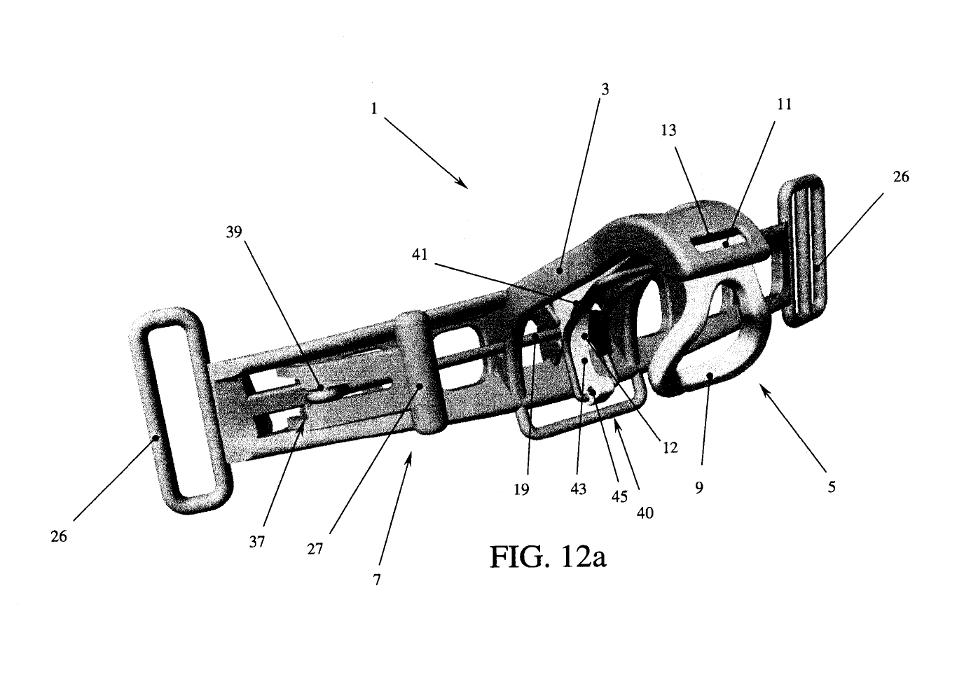

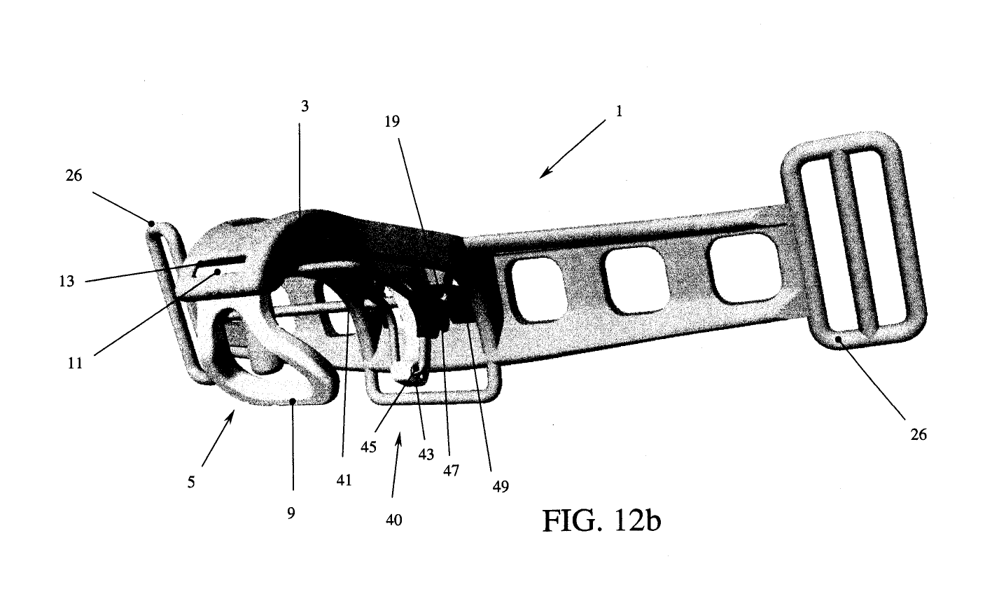

FIGS. 12a and 12b respectively show a perspective view from right and left of another preferred embodiment of the quick-disconnecting device in an operating connecting position;

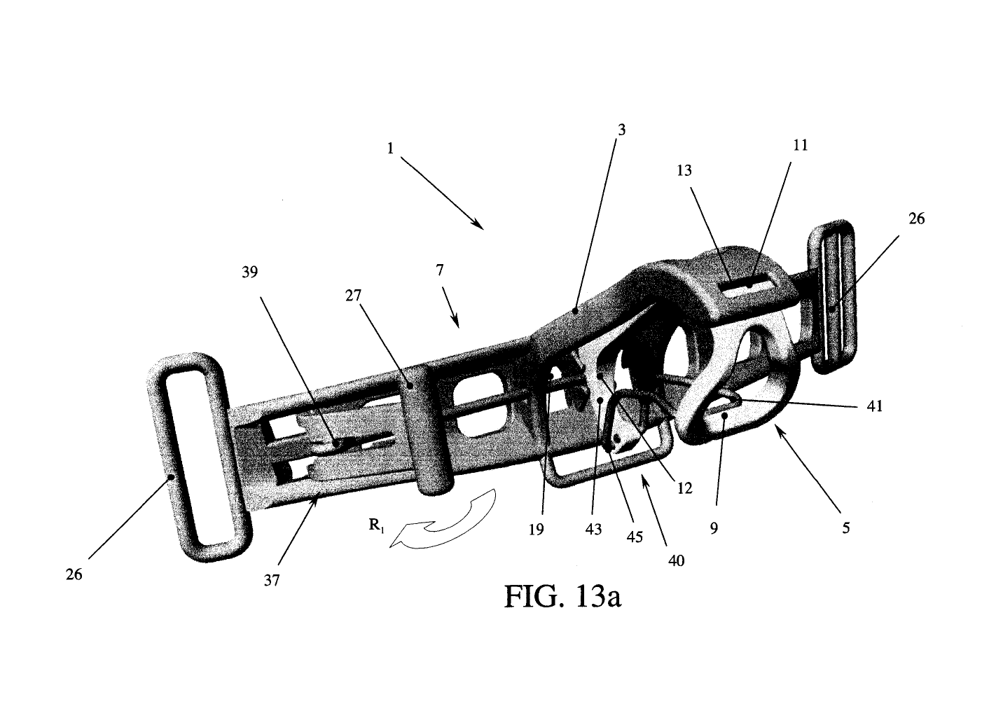

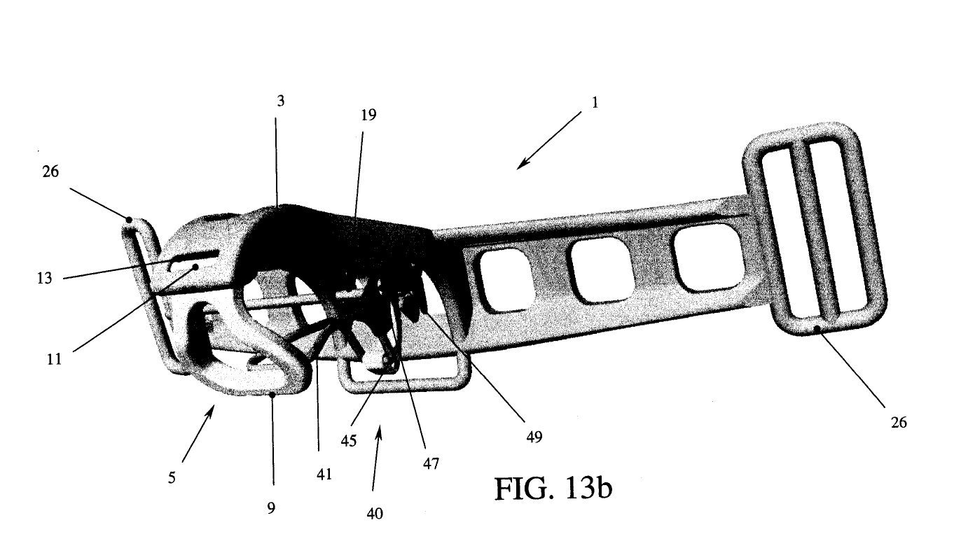

FIGS. 13a and 13b respectively show a perspective view from right and left of the quick-disconnecting device of FIGS. 12a and 12b in an intermediate operating disconnection position;

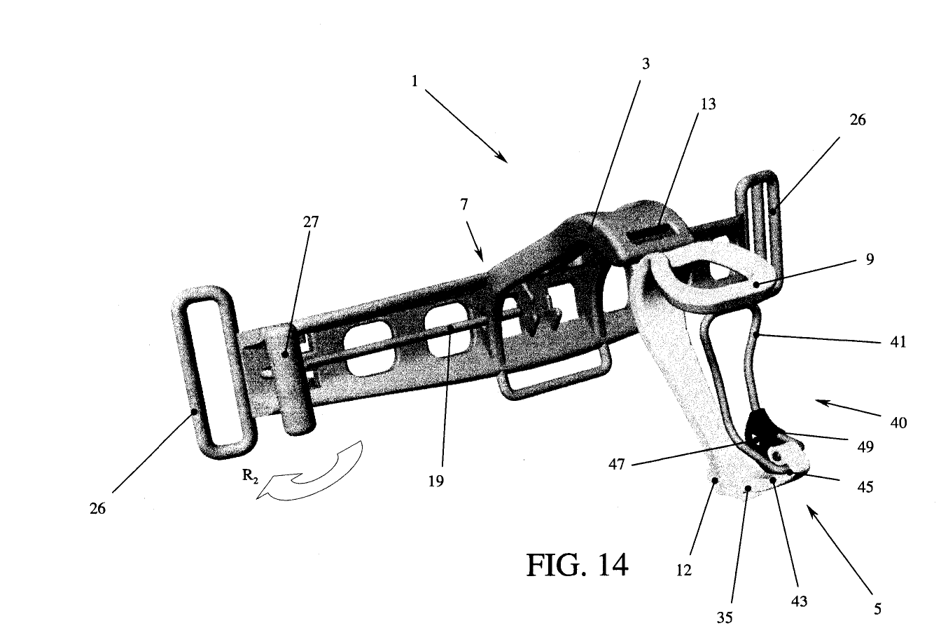

FIG. 14 shows another perspective view from right of the quick-disconnecting device of FIGS. 12a and 12b in an operating disconnecting position; and

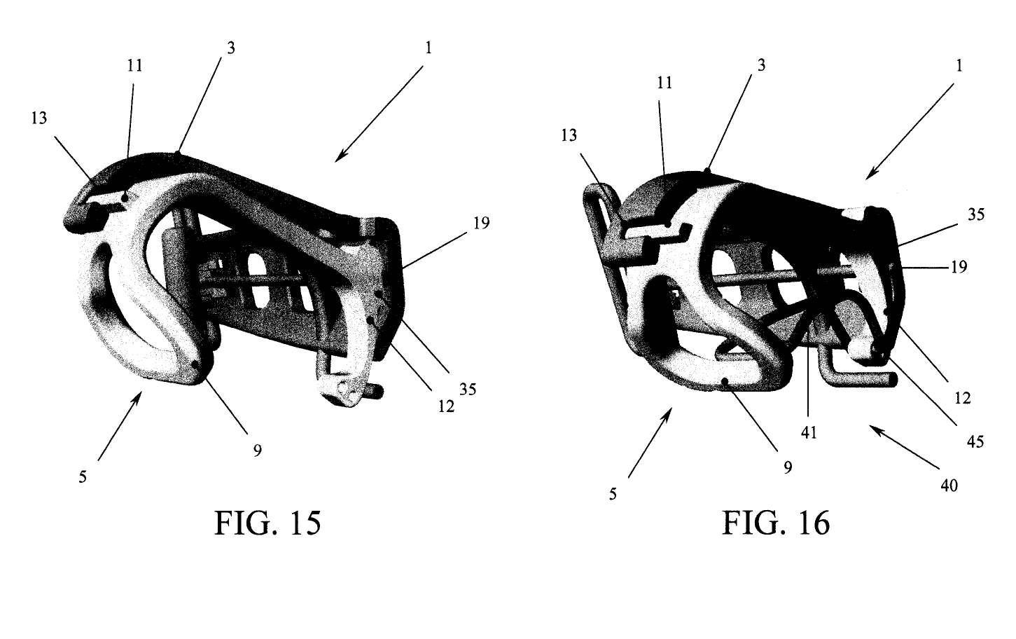

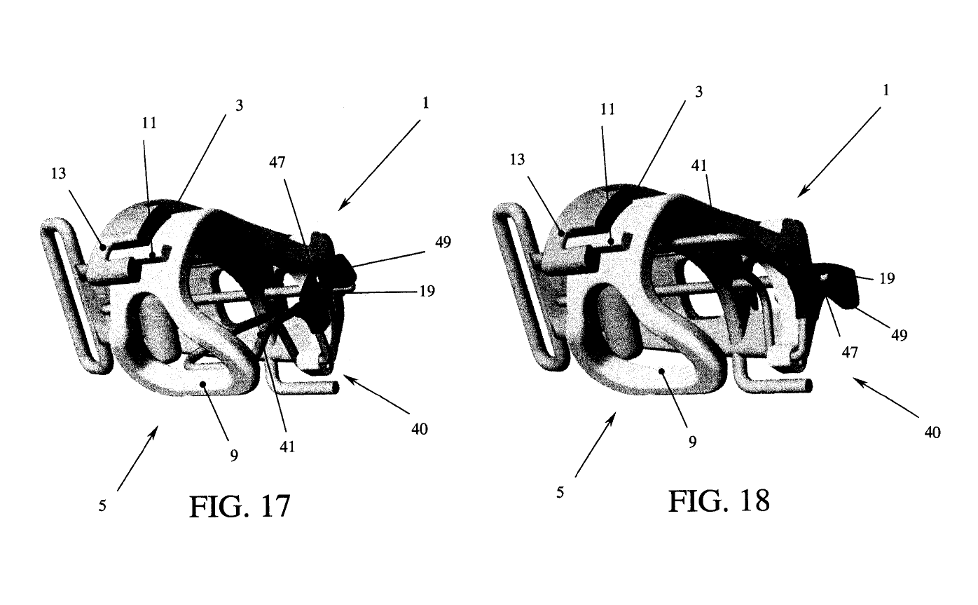

FIGS. 15 to 18 show leftward and partially sectioned perspective views of the quick-disconnecting device of FIGS. 12a and 12b in a sequence of re-arm positions.

With reference to the Figure, it is possible to note that the quick-disconnecting device 1 according to the present invention, in particular for kite-surf, comprises at least one fixed element 3 adapted to be made integral to the body of a user (not shown), for example, as can be seen afterwards in more detail, by interposing a harness or trapezoid of a substantially known type, and at least one moving element 5 having at least one operating connecting position in which such moving element 5 is kept integral with such fixed element 3 by interposing at least one blocking system 7 that can be actuated by such user, and at least one operating disconnecting position in which such moving element 5 is disconnected from such fixed element 3 by actuating such blocking system 7 by such user.

In particular, the moving element 5 is equipped with at least one first connecting end 9 (for example, as shown in the Figure, preferably shaped as a hook) of at least one terminal of a connecting element (for example the chicken loop of a kite-surf) to be disconnected by such user by actuating such blocking system 7.

Such blocking system 7 therefore has at least one first operating position (like the one, for example, shown in FIGS. 2 and 12a) in which such device 1 is in an operating connecting position and such blocking system 7 keeps such moving element 5 integral with such fixed element 3 and at least one second operating position controlled by such user (like the one, for example, shown in FIGS. 4 and 14) in which such device 1 is in an operating disconnecting position and such moving element 5 can be disconnected, under the traction force exerted by the connecting element, from such fixed element 3.

In particular, the blocking system 7 comprises at least one blocking pin 19: in the preferred embodiment of the device 1 according to the present invention, like the one shown in FIGS. 1 to 11, the fixed element 3 is further equipped with at least one through-slit 15 and such moving element 5 further comprises a second end 12, opposed to such first end 9, equipped with at least one projection 17 equipped with at least one through-hole 18. In the preferred alternative embodiment of the device 1 according to the present invention like the one shown in FIGS. 12a to 18, the fixed element 3 comprises the second end 12 equipped with at least one fastening tooth 35. In the preferred embodiment of the device 1 according to the present invention like the one shown in FIGS. 1 to 11, when such device 1 is in its operating connecting position, such projection 17 and the related through-hole 18 are adapted to pass through such through-slit 15 and such blocking pin 19 is adapted to cross such through-hole 18 in order to make such moving element 5 integral with such fixed element 3 while, when such device 1 is in its operating disconnecting position, such blocking pin 19 can be, upon actuation of the user, be completely extracted from such through-hole 18 in order to disengage such moving element 5 from such fixed element 3 and, consequently, disconnect the connecting element from the user.

Alternatively, in the preferred embodiment of the device 1 according to the present invention like the one shown in FIGS. 12a to 18, when such device 1 is in its operating connecting position, the fastening tooth 35 is connected onto the blocking pin 19 (as can be easily seen in FIG. 16) in order to make such moving element 5 integral with such fixed element 3 while, when such device 1 is in its operating disconnecting position, the blocking pin 19 can be, upon actuation by the user, completely axially displaced from such fastening tooth 35 in order to disconnect such moving element from such fixed element 3 and, consequently, disconnect the connecting element from the user.

Advantageously, such moving element 5 cooperates with such fixed element 3 through a lever-type dynamics around a fulcrum point F interposed between such moving element 5 and such fixed element 3: for this purpose, such moving element 5 is equipped with at least one engagement tooth 11 and such fixed element 3 is equipped with at least one seat 13 adapted to house such engagement tooth 11, such engagement tooth 11 engaging such seat 13 to determine the fulcrum point F of the lever-type dynamics around which, in case of actuation of the blocking system 7 to take the device 1 to its operating disconnecting position and under the traction force of such connecting element, such moving element 5 rotates related to such fixed element 3 and is disconnected from the fixed element 3 itself, consequently disconnecting the connecting element from the user.

Obviously, to re-arm the device 1 according to the present invention, namely to take it to its operating connecting position, it is enough to re-connect the moving element 5 to the fixed element 3 inserting the engagement tooth 11 inside the seat 13 and, in the preferred embodiment of the device 1 according to the present invention like the one shown in FIGS. 1 to 11, inserting the projection 17 and its related through-hole 18 through the through-slit 15 and the blocking pin 19 through such through-hole 18 or, as shown for example in particular in FIGS. 15 to 18 in the alternative embodiment of the device 1 according to the present invention, taking back the blocking pin 19 axially next to the fastening tooth 35 and pushing such moving element 5 so that the tooth 35 engages such pin 19: preferably, in order to facilitate such re-arm operation, at least the fastening tooth 35 is made of an elastic material that is flexible enough to allow connecting it to the pin 19 under the thrust action exerted on the moving element 3.

With particular reference to FIG. 5, it is possible to note the dimensional ratios of the lever-type dynamics of the device 1 according to the present invention: in particular, the rectilinear Cartesian projection of the length Y running from the fulcrum point F to the through-hole 18 engaged by the blocking pin 19 of the blocking system 7 of the moving element 5 to the fixed element 3 is substantially equal to X·n, where n□N and X is the rectilinear Cartesian projection of the length running from the fulcrum point F to the contact point between the connecting end 9 of the moving element 5 and the connecting element, and in particular the chicken loop 21 of a connecting cable 23 of the control bar of a kite-surf.

Notwithstanding all that has been exposed above, it is possible to note that the device 1 according to the present invention can comprise at least one supporting band 25 with which the fixed element 3 is made integral, such supporting band 25 being an integral part of a harness or trapezoid or that can be connected, through suitable, substantially known fastening means 26, to this latter one.

Moreover, the blocking system 7 can comprise at least one actuating means 27, preferably shapes as a handle, arranged along such supporting band 25, such actuating means 27 being connected, for example by interposing at least one connecting cable 29 or at least one basculating kinematism 37, to the blocking pin 19 so that, starting from the operating connecting position of the device 1 according to the present invention (like the one for example shown in FIGS. 6, 7 and 8 or 12a and 12b) a traction of such mezzo 27 by the user takes the device 1 according to the present invention to its operating disconnecting position.

In particular, FIGS. 6, 7 and 8 show the embodiment of the device 1 according to the present invention in which the traction of the actuating means 27 by the user, for example along the direction shown by arrow T in FIG. 9, generates, possibly through the simultaneous traction of the connecting cable 29, the complete extraction of the blocking pin 19 from the through-hole 18 to disconnect the moving element 5 from the fixed element 3 and, consequently, the disconnection of the connecting element, like the chicken loop 21 and its related cable 23, from the user.

Alternatively, FIGS. 13a to 14 show the embodiment of the device 1 according to the present invention in which the rotation-translation of the actuating means 27 by the user around the rotation pin 39 of the basculating kinematism 37, for example along the direction of arrows R₁, R₂ of FIGS. 13a and 14, generates the complete axial displacement of the blocking pin 19 from the fastening tooth 35 to disconnect the moving element 5 from the fixed element 3 and, consequently, the disconnection of the connecting element, like the chicken loop and the related cable, from the user.

It has to be noted that, contrary to prior art quick-disconnecting devices, the actuating means 27 are arranged, with respect to the user's body, always in a fixed and determined position, that therefore can be easily located and actuated by the user under any emergency circumstance. It can further be noted how, when the device 1 according to the present invention passes from its operating connecting position to its operating disconnecting position, the disconnection of the connecting element occurs without the chance that any component thereof passes through the user's hands, since the same blocking system, and in particular the actuating means 27, is arranged suitably far away from the connecting element aimed to be disconnected.

In order to increase the safety of the device according to the present invention, it is possible to provide that the blocking system 7 comprises at least one protecting sheath made of transparent material inside which at least the blocking pin 19 can slide, such sheath allowing the user to safely verify that such pin 19 correctly crosses the through-hole 18 or that the fastening tooth 35 is correctly fastened to such pin 19 and therefore that the device 1 is regularly in its operating connecting position.

Moreover, as it is possible to note in particular in FIGS. 10 and 11, the device 1 according to the present invention can be equipped with un automatic re-loading system 31 that can be, in particular, extremely useful for beginners that can have difficulty in using both hands simultaneously in water in order to re-arm the device 1 when the emergency ceases: in particular, such system 31 can comprise at least first elastic means (not shown) aimed to push such blocking pin inside the through-hole 18 and at least one shutter element 33 cooperating with second elastic means (not shown) that, upon completely extracting the blocking pin 19 from the through-hole 18 to disconnect the moving element 5 from the fixed element 3 (for example due to the traction of the actuating means 27 by the user), generate the insertion, for example along the direction shown in FIG. 10 by arrow M₁, of the shutter element 33 inside the through-slit 15 to prevent the first elastic means from taking back the blocking pin 19 in its fastening position and keeping the pin 19 itself in its extracted position. When instead the device 1 according to the present invention is re-armed by re-connecting the moving element 5 to the fixed element 3 by inserting the engagement tooth 11 inside the seat 13, the projection 17 and its related through-hole 18 through the through-slit 15, for example along the directions shown in FIG. 11 by arrows M₂ and M₃, the projection 17 detaches and removes, for example along the direction shown in FIG. 11 by arrows M₄, the shutter element 33 from inside the through-slit 15, allowing the blocking pin 19 to be inserted through the through-hole 18 under the action of the first elastic means.

In order to prevent that, upon disconnecting the moving element 5 from the fixed element 3 due to the actuation by the user of the blocking system and the simultaneous traction exerted by the connecting element connected to the first end 9, the moving element 5 can be lost when the connecting element is withdrawn from such first end 9, the device 1 according to the present invention can further comprise at least one automatic fastening system 40 of such moving element 5 to such connecting element like the one shown, for example, in FIGS. 12a to 18. In particular, such automatic fastening system 40 is adapted to intervene when the device 1 passes from its operating connecting position to its operating disconnecting position in order to fasten the moving element 5 to the connecting element.

Preferably, such automatic fastening system 40 comprises at least one closing lever 41 having an open position (like the one shown, for example, in FIGS. 12a and 12b) in which such lever 41 is adapted to make an open loop in the moving element 5 with the first end 9 and a closed position in which such lever 41 is adapted to make a closed loop in the moving element 5 with such first end 9.

Preferably, such lever 41 is of the snap type, through elastic means (not shown) interposed between the moving element 5 and the lever itself, such elastic means being adapted to spontaneously take, when there are no obstructions, such lever 41 from such open position to such closed position.

In particular, the second end 12 is equipped with at least one appendix 43 to which the closing lever 41 is connected by interposing at least one hinge-type kinematism 45 to be able to pass from such open position to such closed position and vice versa.

Moreover, the closing lever 41 is equipped with at least one blocking hole 47, such hole being adapted to be engaged by the blocking pin 19 in order to keep such lever 41 in its open position when the device 1 according to the present invention is in its operating connecting position: when instead the blocking pin 19 is disengaged from the blocking hole 47, the closing lever 41 automatically passes to its closed position (like the one shown, for example, in FIGS. 13a to 14) preferably under the action of the related elastic means. Preferably, the blocking hole 47 is arranged on at least one tongue 49 integral with such lever 41, such tongue 49 being preferably made of a flexible elastic material. Therefore, when the device 1 is in its operating connecting position, the blocking pin 19 engages the blocking hole 47 to keep the lever 41 in its open position: when such device 1 passes to its operating disconnecting position, the blocking pin 19 can be disengaged, upon actuation by the user, from such blocking hole 47 in order to allow the lever 41 to pass to its closed position.

In particular, FIGS. 12a to 14 show the embodiment of the device 1 according to the present invention in which a first rotation-translation portion of the actuating means 27 by the user, for example along the direction shown by arrow R₁, takes the device 1 to an intermediate disconnecting operating position in which the blocking pin 19 is taken to disengage the blocking hole 47 to allow the lever 41 to pass to its closed position: going on with a second rotation-translation portion of the actuating means 27 by the user, for example along the direction shown by arrow R₂, the device 1 is taken to its operating disconnecting position, according to the above described modes, by disengaging the moving element 5 from the fixed element 3 and, consequently, disconnecting the connecting element, like the chicken loop and its related cable, from the user, such connecting element being however kept fastened to the moving element 5 inside the closed loop made by the closing lever 41 in its closed position in cooperation with the first end 9.

With particular reference to FIGS. 15 to 18, it is possible to note that, in order to re-arm the device 1 according to the present invention equipped with the automatic fastening system 40, namely in order to take it to its operating connecting position, in addition to what has been described above, it is enough, after having reconnected the moving element 5 to the fixed element 3 by inserting the engagement tooth 11 inside the seat 13 (FIGS. 15, 16 and 17), to manually take back the closing lever 14 to its open position with the blocking pin 19 engaging the blocking hole 47 (FIG. 18): in particular, this last operation is facilitated by the tongue 49 flexibility. The same flexibility of the tongue 49 can allow the user to manually disengage the blocking hole 47 from the pin 19 in order to voluntarily take the closing lever 41 to its closed position without having to take the device 1 according to the present invention to its operating disconnecting position: such possibility can be particularly appreciated by users that employ kite-surfs, since it allows them to use the device 1 according to the present invention indifferently in both constrained and free arrangements.

Obviously, merely as an example, the quick-disconnecting device 1 according to the present invention has been described in particular as applied to the practice of kite-surfs, but it is wholly evident that the same device 1 can find application in any other context in which the same operating features are required, such as, for example, for practicing windsurf, sailing sports, mountaineering, etc.

1-20. (canceled)

21. A quick-disconnecting device, in particular for kite-surf, comprising at least one fixed element adapted to be made integral with a body of a user and at least one moving element having at least one operating connecting position in which the moving element is kept integral with the fixed element by interposing at least one blocking system that can be actuated by the user, and at least one operating disconnecting position in which the moving element is disconnected from the fixed element by actuating the blocking system by the user, the moving element being equipped with at least one first end adapted to make a connection, preferably shaped as a hook, with at least one terminal of a connecting element to be disconnected by the user by actuating the blocking system, the moving element cooperating with the fixed element through a lever-type dynamics around a fulcrum point interposed between the moving element and the fixed element, wherein the blocking system comprises at least one blocking pin, the fixed element being further equipped with at least one through-slit and the moving element further comprising a second end, opposed to the first end, equipped with at least one projection equipped with at least one through-hole, when the device is in its operating connecting position the projection and the through-hole being adapted to pass through the through-slit and the blocking pin being adapted to cross the through-hole in order to make the moving element integral with the fixed element while, when the device is in its operating disconnecting position, the blocking pin being completely extracted, upon actuation by the user, from the through-hole to disconnect the moving element from the fixed element.

22. The quick-disconnecting device of claim 21, wherein the device further comprises at least one system for automatically fastening the moving element to the connecting element.

23. The quick-disconnecting device of claim 21, wherein the moving element is equipped with at least one engagement tooth and the fixed element is equipped with at least one seat adapted to house the engagement tooth, the engagement tooth engaging the seat to determine the fulcrum point of the lever-type dynamics around which, in case of actuation of the blocking system to take the device to its operating disconnecting position and under a traction force of the connecting element, the moving element rotates related to the fixed element and is disengaged from the fixed element.

24. The quick-disconnecting device of claim 23, wherein the blocking system has at least one first operating position in which the device is in an operating connecting position and the blocking system keeps the moving element integral with the fixed element and at least one second operating position controlled by the user in which the device is in an operating disconnecting position and the moving element can be disconnected, under the traction force exerted by the connecting element, from the fixed element.

25. The quick-disconnecting device of claim 21, wherein the blocking system comprises at least one blocking pin, the moving element further comprising a second end, opposed to the first end, equipped with at least one fastening tooth, when the device is in its operating connecting position, the fastening tooth being fastened onto the blocking pin to make the moving element integral with the fixed element, while when the device is in its operating disconnecting position, the blocking pin being, upon actuation by the user, axially completely moved from the fastening tooth in order to disengage the moving element from the fixed element, at least the fastening tooth being preferably made of a flexible elastic material.

26. The quick-disconnecting device of claim 21, wherein a rectilinear Cartesian projection of a length Y running from the fulcrum point to the through-hole engaged by the blocking pin of the blocking system is substantially equal to X·n, where nεN and X is a rectilinear Cartesian projection of a length running from the fulcrum point to a contact point between the connecting end of the moving element and the terminal of the connecting element.

27. The quick-disconnecting device of claim 21, wherein it comprises at least one supporting band with which the fixed element is made integral, the supporting band being an integral part of a harness or trapezoid or adapted to be connected, through suitable fastening means to the harness or trapezoid.

28. The quick-disconnecting device of claim 27, wherein it comprises at least one actuating means arranged along the supporting band, the actuating means being connected to the blocking pin, the blocking system comprising at least one protecting sheath made of transparent material inside which the blocking pin can slide.

29. The quick-disconnecting device of claim 21, wherein the device comprises an automatic re-loading system, the automatic re-loading system comprising at least first elastic means aiming to push the blocking pin inside the through-hole and at least one shutter element cooperating with second elastic means that, upon a complete extraction of the blocking pin from the through-hole, make the shutter element be inserted inside the through-slit, upon re-arming the device the projection disengaging and removing the shutter element from inside the through-slit allowing the blocking pin to be inserted through the through-hole under the action of the first elastic means.

30. The quick-disconnecting device of claim 22, wherein the automatic fastening system is adapted to intervene when the device passes from the operating connecting position to the operating disconnecting position to fasten the moving element to the connecting element.

31. The quick-disconnecting device of claim 22, wherein the automatic fastening system comprises at least one closing lever having an open position in which the closing lever is adapted to make an open loop in the moving element with the first end and a closed position in which the closing lever is adapted to make a closed loop in the moving element with the first end.

32. The quick-disconnecting device of claim 31, wherein the closing lever is of a snap type through elastic means interposed between the moving element and the closing lever, the elastic means being adapted to spontaneously take, without obstructions, the closing lever from the open position to the closed position.

33. The quick-disconnecting device of claim 31, wherein the moving element comprises a second end opposed to the first end, the second end being equipped with at least one appendix to which the closing lever is connected by interposing at least one hinge-type kinematism to be able to pass from the open position to the closed position and vice versa.

34. The quick-disconnecting device of claim 31, wherein the closing lever is equipped with at least one blocking hole adapted to be engaged by the blocking pin to keep the lever in the open position when the device is in the operating connecting position, while when the blocking pin disengages the blocking hole, the closing lever passes to the closed position.

35. The quick-disconnecting device of claim 29, wherein the blocking hole is arranged on at least one tongue integral with the closing lever, the tongue being preferably made of a flexible elastic material.
